(19) United States
(12) Patent Application Publication
(10) Pub. No.: US 2013/0210018 A1
(43) Pub. Date: Aug. 15, 2013

(54) Polymer Particle

(71) Applicant: Martin Garnett, Cardiff (GB)

(72) Inventor: Martin Garnett, Cardiff (GB)

(73) Assignee: DNA Tracer Technologies Limited

(21) Appl. No.: 13/814,768

(22) PCT Filed: Aug. 11, 2011
(86) PCT No.: PCT/GB2011/001207

§ 371 Date: Apr. 10, 2013

(30) Foreign Application Priority Data
Aug. 11, 2010 (GB) 1013519.2

(51) Int. Cl. C08G 69/48

(52) U.S. Cl. CPC C08G 69/48
USPC 435/6.12; 525/432; 428/402

(57) ABSTRACT

A particle [1] comprising a nucleic acid molecule [2] and a poiyamicioamine (PAA) polymer [4], wherein both the nucleic acid molecule [2] and the PAA polymer [4] comprise a pendant disulphide, sulphydryl or activated sulphydryl moiety and are capable of cross-linking with each other. The particle further comprises stabilising cross-linkers [6] & [7].

### FIELD OF THE INVENTION

The invention relates to a polymer particle comprising a nucleic acid molecule and a polyamidoamine polymer. It also relates to a method of making the particle, and to a method of marking a material with the particle and determining whether a material has been marked. The use of the particle in marking a material, e.g. a liquid such as groundwater, is also an aspect of the invention.

### BACKGROUND

There are many circumstances in which it is useful to track the movement of a material in the environment, for example, in groundwater studies. Groundwater studies can be used to determine the direction and/or velocity of groundwater movement, as well as potential pollutants that could contaminate, and be carried by, the water.

It is known that groundwater tracers can be naturally occurring, e.g. heat carried by a stream of geothermal water, or minerals that have been leached from the surrounding environment. Alternatively, tracers can be introduced, e.g. via sink holes, to determine the connectivity of the sink site with downstream tracer detection sites.

It is known to use fluorescent tags to mark materials in such circumstances. However, there are problems with this approach, primarily because of a limit to the number of readily distinguishable tags in existence. In view of the limited number of tags available, often only one study can be carried out in a particular area at a time. Furthermore, if a study is to be repeated, sufficient time must be allowed for the original tag to disperse in the environment so as to avoid any tag from the original study being counted in the repeated study. Also, fluorescent tags behave in a different way to, e.g. beads, when used in a groundwater tracer system because dye can pass through very small fissures. This results in a moderate, slow time-travel curve as shown in FIG. 1.

There have previously been proposals for the marking of materials using a particle comprising a nucleic acid tag. For example, WO2007/148058 discloses a particle for tagging a liquid wherein the particle comprises a nucleic acid tag, a carrier nucleic acid and a linear polymer. This particle is particularly suited for use in tracing materials which are to be tracked over a short timescale because it persists only for a brief duration, e.g. days, or less. Therefore, it is particularly useful as, e.g. a surface water tracer because surface water typically only needs to be tracked over these short durations.

WO 2008/038038 discloses carrier particles which may be used to deliver biomolecules, and that can be used in an environmental tracking system. The particles comprise a polyamidoamine polymer comprising a pendant disulphide, sulphydryl or activated sulphydryl moiety, wherein these sulphydryl groups react to form cross-links (disulphide bridges). The disulphide bridges impart partial stability to the particles. It is possible to reverse the cross-linking reaction under reducing conditions, i.e. the particles de-stabilise under reducing conditions. Such polymers are also discussed in the article “Sterically stabilized self-assembling reversibly cross-linked polyelectrolyte complexes with nucleic acids for environmental and medical applications” by Garnett et al., Biochem. Soc. Trans (2009) 37, 713-716.

In order to trace and detect the movement of certain materials, such as groundwater, it is necessary for the tracer to be persistent, i.e. the tracer should preferably last for weeks or months; it can take groundwater such extended periods of time to travel between sites. The tracer particles in the prior art are not ideally suited for conducting such studies because the stability of the particle is not sufficient to protect and preserve a nucleic acid molecule in the environment for a sustained period of time. Therefore, they would not yield accurate results for the movement of a material, wherein the sampling process takes place over a period of weeks or months following the addition of the tracer.

The present invention seeks to alleviate the above problem.

### STATEMENTS OF INVENTION

According to one aspect of the invention, there is provided a polymer particle comprising:
a nucleic acid molecule comprising a pendant disulphide, sulphydryl or activated sulphydryl moiety; and
a polyamidoamine polymer comprising a pendant disulphide, sulphydryl or activated sulphydryl moiety,
wherein the nucleic acid molecule is covalently cross-linked with the polyamidoamine polymer.

Disuplhide bonds between the poluamidoamine and the nucleic acid molecule are stronger than ionic interactions alone, and so stabilise the particle.

Conveniently, the polyamidoamine polymer contains repeating groups X and Y, wherein the polymer is represented by the general formula I:—

{—[X]—[Y]—}ₙ (Formula I)

in which,
n is between 5 and 500;
the groups X, which may be the same or different, are amide-containing groups of the formula

-[-L¹-CO—NR¹-L²-NR²—CO-L³-]-

wherein
L¹ and L³ independently represent optionally substituted alkylene chains, preferably optionally substituted ethylene groups; and advantageously L¹ and L³ independently represent unsubstituted alkylene chains, preferably unsubstituted ethylene groups;
L² represents an optionally substituted alkylene chain and preferably L² represents an unsubstituted alkylene chain; and
R¹ and R² independently represent hydrogen or an optionally substituted alkyl group, and preferably, R¹ and R² independently represent an unsubstituted alkyl group,
and the groups Y, which may be the same or different, represent amine-derived groups of the formula:—

—[—NR³—]— or —[—NR⁴-L⁴-NR⁵—]—

wherein
R³, R⁴ and R⁵ independently represent optionally substituted alkyl groups, and preferably R³, R⁴ and R⁵ independently represent unsubstituted alkyl groups, and
L⁴ represents an optionally substituted alkylene group, and preferably L⁴ represents an unsubstituted alkylene group,
or R⁴, R⁵ and L⁴, together with the nitrogen atoms to which they are attached, form an optionally substituted ring,
with the proviso that at least some of R³, R⁴ and R⁵ contain disulphide, sulphydryl or activated sulphydryl groups.

Preferably R¹ and R² are hydrogen. Where R1 and/or R2 represent an optionally substituted alkyl group or an unsubstituted alkyl group, it is most preferably an alkyl group containing a C₁-C₂₀ chain, more suitably, a C₁-C₁₀ chain, and more preferably, a C₁-C₅ chain.

R³, R⁴ and R⁵, most preferably represent optionally substituted alkyl groups or unsubstituted alkyl groups, containing a C₁-C₂₀ chain, more suitably, a C₁-C₁₀ chain, and even more suitably a C₁-C₅ chain.

L² and L⁴ most preferably represent optionally substituted alkylene chains containing 1-10 carbon atoms, more suitably 1-5 carbon atoms, and most suitably 1-3 carbon atoms. L² and L⁴ are preferably unsubstituted. L² most preferably represents —CH₂—. L L⁴ most preferably represents —CH₂CH₂—.

Where any of L¹, L², L³ and L⁴ are substituted, the substituents may be selected from a wide range, including without limitation alkyl, alkoxy, acyl, acylamino, carboxy, cyano, halo, hydroxyl, nitro, trifluoromethyl and amino.

Where R¹ and/or R² is substituted, the substituents may be selected from a wide range, including without limitation alkyl, alkoxy, acyl, acylamino, carboxy, cyano, halo, hydroxy, nitro, trifluoromethyl and amino.

Where any of R³, R⁴ and R⁵ are substituted, the substituents may be selected from a wide range, including without limitation alkyl, alkoxy, acyl, acylamino, carboxy, cyano, halo, hydroxy, nitro, trifluoromethyl and amino. At least some of R³, R⁴ and R⁵ are substituted by groups selected from sulphydryl, activated sulphydryl and —S—S—R⁶ wherein R⁶ represents alkyl optionally substituted by one or more substituents selected from a wide range, including without limitation alkyl, alkoxy, acyl, acylamino, carboxy, cyano, halo, hydroxy, nitro, trifluoromethyl and amino.

Unless the context indicates otherwise, references herein to alkyl groups should be taken to indicate optionally substituted alkyl groups containing a C₁-C₂₀ chain, more suitably, a C₁-C₁₀ chain, and even more suitably, a C₁-C₅ chain.

In Formula I, n may be between 5 and 400, more suitably, between 10 and 300, and most suitably between 20 and 100.

Preferably, the Molecular Weight of the PAA polymer is between 1500 Da and 120,000 Da, more preferably, between 3,000 Da and 90,000 Da, even more preferably, between 4,000 Da and 60,000 Da, and most preferably, between 6,000 Da and 30,000 Da.

Advantageously, the polyamidoamine polymer is bonded to a poly(ethylene glycol) group at one or both of its terminal ends. Poly(ethylene glycol) is hydrophilic and neutral, and when arranged on the surface of the particle, it minimises adsorption processes.

Preferably, the particle further comprises a cationic cross-linking homopolymer, XLP, having the formula:

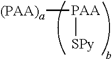

wherein the ratio of a/b is 3
wherein PAA represents {—[X]—[Y]—} as defined in claim 2 and SPy represents a sulphur pyridyl moiety, and wherein the XLP is cross-linked with the nucleic acid molecule and the polyamidoamine polymer.

Conveniently, the XLP used for cross-linking has the formula:

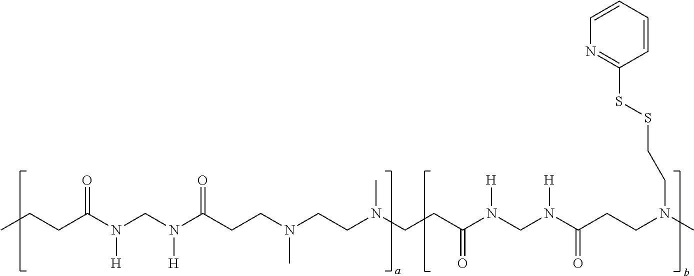

wherein the ratio of a/b is 3.

Advantageously, the particle further comprises a second cross-linker (XL2), wherein the XL2 used for cross-linking is selected from the group consisting of:
1,4-bismaleimidyl-2,3-dihydroxybutane (BMDB);
1,8-bis-maleimidodiethyleneglycol (BM(PEG)2);
1,11-bis-maleimidotriethyleneglycol (BM(PEG)3);
1,4-bismaleimidobutane (BMB);
bismaleimidohexane (BMH);
bismaleimidoethane (BMOE);
1,4-di-[3′-(2′-pyridyldithio)-propionamido]butane (DPDPB);
dithio-bismaleimidoethane (DTME);
1,6-hexane-bis-vinylsulfone (HBVS); and
tris-[2-maleimidoethyl]amine (TMEA),
   and wherein the XL2 is cross linked with the XLP, the nucleic acid molecule and the polyamidoamine polymer, so as to bind the nucleic acid and the XLP to the polyamidoamine polymer.

Alternatively, when the XL2 is present in the particle the (first) XLP crosslinker is omitted, or it has a structure other than that defined by the formula above.

Preferably, the XL2 used for cross-linking is 1,4-bismaleimidyl-2,3-dihydroxybutane (BMDB):

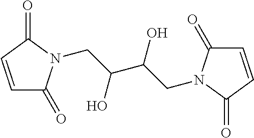 [SMILES: O=C1C=CC(=O)N1CC(O)C(O)CN1C(=O)C=CC1=O]

BMDB can be cleaved by periodate and so the nucleic acid may be easily released on demand.

Conveniently, the XLP and XL2 are present in a ratio of between 1:1.5 and 1:3, most preferably 1:2. The ratio is a molar ratio.

Advantageously, the polyamidoamine polymer has the formulation:

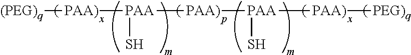

in which
PAA represents {—[X]—[Y]—} as defined in claim 2,
PEG represents poly(ethylene glycol),
wherein m is independently between 1 and 25, preferably between 1 and 10, most preferably 4;
p is between 3 and 350, preferably between 5 and 50, most preferably 24;
q is independently between 1 and 60, preferably between 10 and 50, most preferably 38; and
x is independently between 0 and 50, preferably between 10 and 40, most preferably 24.

That is, n (as defined above)=p+2 m+2x. This positioning of the —SH groups near to the terminal PEG groups arranges the polyamidoamine polymer within the particle such that the PEG groups are on the outer surface.

Preferably, the particle has a diameter of 70 to 200 nm.

In a preferred embodiment, the particular size is calculated by laser diffraction. Preferably, the laser diffraction instrument is a Malvern Instrument. Suitably, the laser diffraction instrument uses Mie Theory as the basis of size calculations. [http://www.azom.com/article.aspx?ArticleID=1528]

Conveniently, the nucleic acid molecule is between 80 and 100 bp long.

Advantageously, the nucleic acid molecule is a single stranded oligonucleotide, preferably a single stranded DNA molecule.

Preferably, the pendant disulphide, sulphydryl or activated sulphydryl moiety of the nucleic acid molecule is present at the 5′ end.

In accordance with a further aspect of the invention, there is provided a method of making a polymer particle, comprising the steps of:
i). reducing a XLP;
ii). adding a XL2 to the XLP;
iii). combining a polyamidoamine polymer with the XLP-XL2 complex; and
iv). mixing the nucleic acid molecule with the PAA-XL2-XLP complex.

These steps allow the XLP and XL2 to bind together prior to interacting with the polymer and the nucleic acid. The XL2 binds the nucleic acid molecule and the polymer together by means of thioether bonds, and the XLP increases the stability of the complex overall.

In accordance with a still further aspect of the invention, there is provided a method of marking a material comprising the steps of:
i). providing one or more particles of the invention; and
ii). applying the particles to the material.

Preferably, the material is groundwater.

According to a further aspect of the invention there is provided a method of detecting whether a material has been marked as defined above, comprising the steps of:
iii). sampling a portion of the material; and
iv). detecting the presence of the nucleic acid molecule in the sample.

Advantageously, step iv). further comprises the step of concentrating the amount of nucleic acid molecule by sample filtration.

Conveniently, step iv). further comprises the step of extracting the nucleic acid molecule from the marker particles.

Preferably, step iv). further comprises the step of determining the quantity of the nucleic acid molecule present in the sample, preferably by real time PCR.

Conveniently, step iii). of the method of detecting a material is carried out at least one week after step ii). of the method of marking a material has occurred.

In accordance with another aspect of the invention there is provided a method of marking a plurality of materials comprising the steps of marking a material as described above, wherein each material is marked with a separate set of polymer particles, the polymer particles in each set comprising nucleic acid molecule having a different sequence.

According to yet another aspect of the invention there is provided the use of a polymer particle according to the invention for marking a material.

In this specification, the term “pendant moiety” means a side group that is attached to the main chain, but which is not part of the main chain. The term “cross-link” used herein means a covalent bond formed between two separate molecules, for example, a disulphide bond or a thioether bond. “Groundwater” means water that is located underground in soil pore spaces and in pervious rocks. Herein, the terms “thiol” and “sulphyhdryl” are used interchangeably.

### SPECIFIC DESCRIPTION

In order that the present invention is more readily understood and so that further features thereof may be appreciated, embodiments of the invention will now be described, by way of example, with reference to the accompanying figures.

### FIGURES

FIG. 1 is graph showing the different time-travel curves resulting from the use of a fluorescent dye and a particle as a groundwater tracer;

FIG. 2 shows the reaction that occurs between XLP and DMDB;

FIG. 3 shows the reaction that occurs between XL2-DMDB and the copolymer (CP) and the nucleic acid molecule;

FIG. 4 is a schematic overview of the bonding between the copolymer, the XLP-XL2 complex and the nucleic acid molecule;

FIG. 5 is a schematic of a particle in accordance with the present invention;

FIG. 6 is a bar chart showing particle sizes of 1.25 to 1 polyamidoamine (PAA) to DNA ratio and 1 to 1 XLP-BMDB to copolymer (CP), 1.25 to 1 XLP-BMDB to copolymer (CP) and 1.5 to 1 XLP-BMDB to copolymer (CP). The first three particles are made with a non-thiolated oligonucleotide while the last three are made with a thiolated oligonucleotide; and

FIG. 7 is a bar chart showing particle sizes of 1.25 to 1 polyamidoamine (PAA) to DNA ratio and 1 to 1 XLP-BMDB to copolymer (CP) using a non-thiolated and a thiolated oligonucleotide.

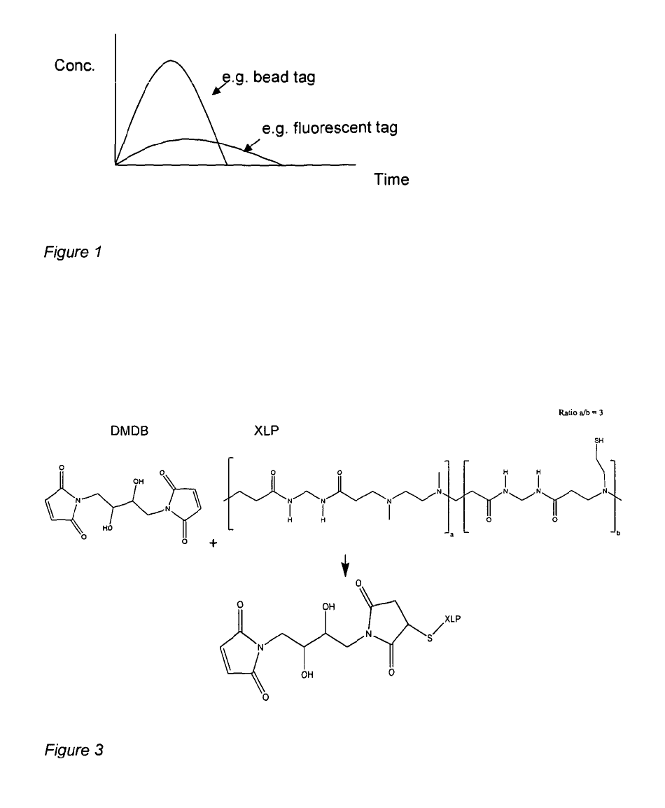

Referring to FIG. 1, in accordance with a first embodiment of the invention, a particle or bead [1] comprises a combination of a nucleic acid tag [2], a copolymer (CP) [3] wherein the copolymer comprises a linear, thiolated polyamidoamine (PAA) [4] with terminal polyethylene glycol (PEG) groups [5], a cationic cross-linking homopolymer (XLP) [6] and a second cross-linker (XL2) [7] being DMDB (1,4-bismaleimidyl-2,3-dihdroxybutane). The nucleic acid tag [2] comprises a plurality of identical single stranded DNA oligonucleotides of between 80 and 100 bp, wherein a proportion of the oligonucleotides are thiolated at the 5′ end.

The linear polyamidoamine polymer [4] has a backbone comprising amido and tertiary amino groups arranged regularly on the backbone, and further comprises pendant disulphide, sulphydryl or activated sulphydryl moities. Such polymers and the synthesis thereof are disclosed in WO 2008/038038, which is hereby incorporated by reference in its entirety.

The XLP [6] and the DMBD [7] are present in a molar ratio of 1:2, and the XLP [6] and the copolymer [3] are provided in a molar ratio of 1.5:1. The nucleic acid tag [2] and polymer [4] are present in a ratio of 1.25:1, wherein the ratio is calculated based on the number of DNA bases per monomer of the polymer. It is advantageous to have a greater proportion of reduced thiol compared to activated thiol to ensure full cross-linking. In alternative embodiments the ratio of XLP [6] and DMBD [7] ranges from 1:1.5 to 1:3, the ratio of XLP [6] and copolymer [3] ranges from 1:1 to 2.5:1, and the ratio of nucleic acid tag [2] to polymer [4] ranges from 1:1 to 2.5:1.

In an alternative embodiment, the particle [1] comprises a thiolated nucleic acid tag [2] and a linear, thiolated polyamidoamine (PAA) [4] or copolymer [3] in the absence of XLP [6] and DMDB [7]. The thiol groups on the nucleic acid tag [2] and the polyamidoamine [4] form disulphide bonds, which impart stability on the particle [1] beyond that provided by ionic interactions between the nucleic acid tag [2] and the polyamidoamine [4]. In a still further embodiment the particle [1] comprises a thiolated nucleic acid tag [2], a linear, thiolated polyamidoamine (PAA) [4] or copolymer [3] and DMBD [7] in the absence of XLP [6]. Varying the composition of the particle [1] alters particle [1] stability.

The nucleic acid tags [2] have a sequence that is selected to be unique so as to identify the particle [1] in which it is encapsulated. The tag [2] does not, therefore, correspond to any naturally occurring or synthetic protein-encoding sequence.

In preferred embodiments, the nucleic acid tag [2] comprises a stop codon within it so that, even if the sequence should become incorporated into a living organism, it cannot be expressed as a protein. In particularly preferred embodiments, three stop codons are provided, staggered into the three separate reading frames. In these embodiments, the sequence cannot be translated into a protein, irrespective of the reading frame in which it is incorporated into an organism.

In alternative embodiments, the nucleic acid tag [2] comprises a naturally occurring sequence such as a DNA sequence of a common agricultural crop (e.g. Zea mays). It is preferred that the tag comprises non-coding or “junk” DNA from the natural source. The advantage of using such naturally occurring DNA sequences is that there is no risk of contamination of the environment with artificial or genetically modified DNA sequences.

It is to be appreciated that, in practice, a range of different nucleic acid tags [2] are required for marking different materials or different locations. All of the nucleic acid tags in one particular set of beads have the same identifying sequence but different sets of beads have nucleic acid tags with different sequences.

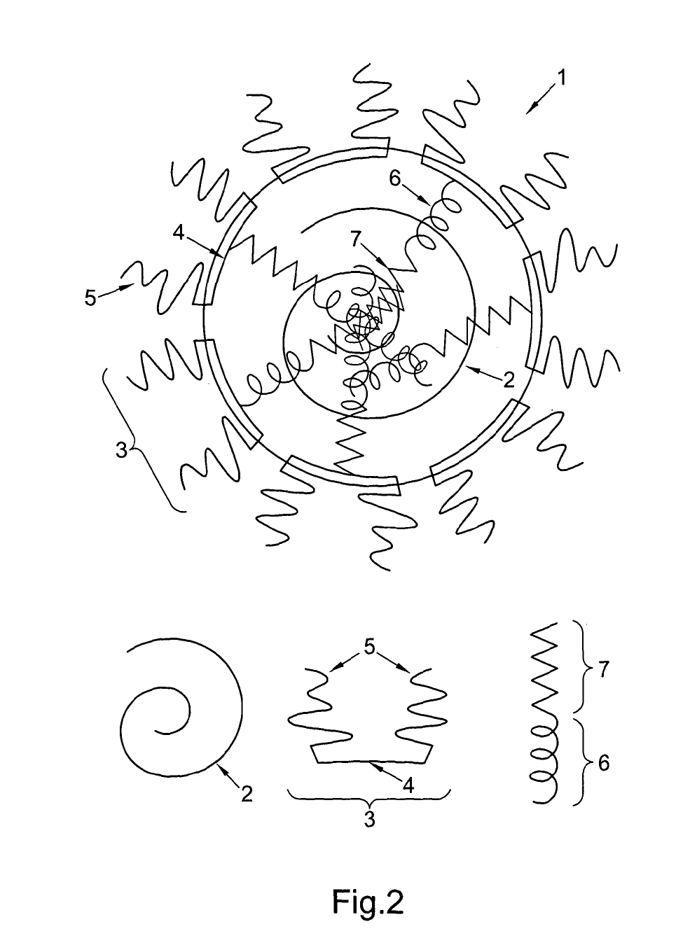

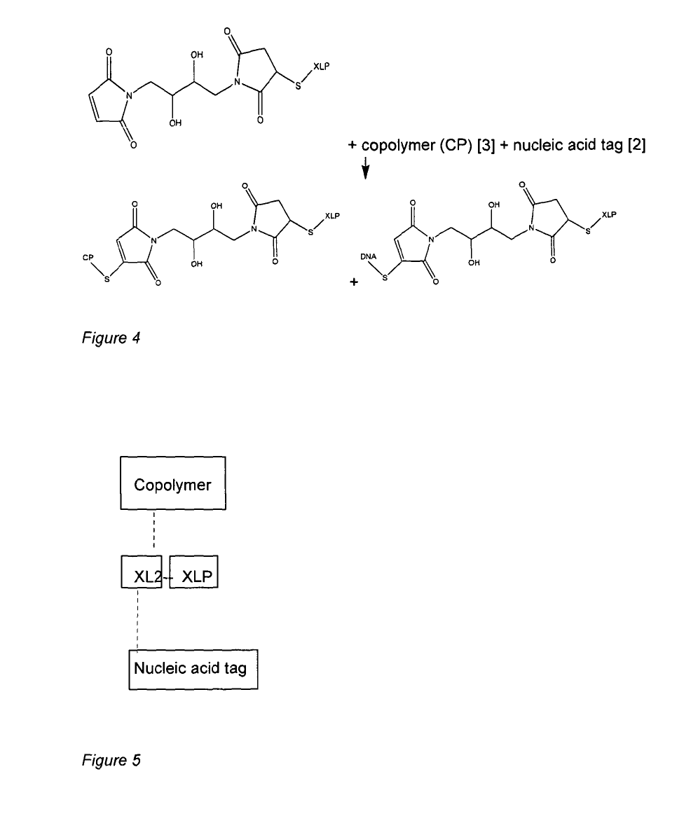

There is also provided a method of making a particle or bead [1] of the present invention. Firstly the XLP cross-linker [6] is reduced to provide XLP with a free —SH thiol group. The XLP is then combined with DMDB, wherein there is an excess of BMDB (1:2 ratio of XLP:DMDB), and the XLP [6] and BMDB [7] bind together. This reaction is shown in FIG. 3. Referring to FIG. 4, the copolymer [3] is added to the reaction and the BMDB within the XLP-BMDB complex forms thioether bonds with the thiol side groups of the polyamidoamine polymer [4]. Subsequently the nucleic acid tag [2], wherein some tags [2] are thiolated at their 5′ end, are added, and the BMDB forms thio-ether cross links with the —SH groups on the nucleic acid tag [2]. Therefore, as depicted in FIG. 5, the nucleic acid tags [2] are indirectly bound to the copolymer [3] via thioether linkages. These linkages provide a stable means of binding the nucleic acid tag [2] (and cross-linkers [6] & [7]) to the structural polymer [4]. The particle [1] is capable of withstanding reducing conditions and its survivability in e.g. groundwater, is increased to span weeks or months. This is in contrast to particles wherein the polyamidoamine polymer is cross-linked by virtue of disulphide bonds rather than thioether linkages, i.e. those not comprising BMDB. In addition, once the particle [1] is formed, there are ionic interactions between the negatively charged nucleic acid tag [2] and the cationic polymers [3] and [6] within the centre of the particle.

The copolymer [3] comprises polyamidoamide polymer [4] and terminal PEG groups [5]. The PEG groups [5] are linked to the polyamidoamine polymer [4] through a piperazine moiety. There are 38 repeating PEG [5] units present at either end of the copolymer [3]. The thiol side groups of the polyamide polymer [4] are separated from the PEG group [5] by 24 polyamidoamine (PAA) repeating units, i.e. they are located in proximity to the PEG groups [5]. Such positioning of the thiol groups ensures that cross-linking with the polyamidoamine polymer takes place near the surface of the particle [1] and forces the PEG groups [5] to the outside of the particle [1].

The particles form in such a manner that the PEG residues [5] of the copolymer [3] are located on the outer surface of the particle [1]. They provide a dense, hydrophilic system on the particle surface and help to protect the nucleic acid tag [2] inside the particle [1]. The PEG [5] sterically stabilised surface provides a neutral charge and an entropic barrier. It prevents unwanted aggregation and adsorption of the particles [1], e.g it prevents ionic or electrostatic binding of the particle within the environment, e.g. to minerals in water.

The particles [1] that are formed are spherical and have a diameter of 80 nm. In alternative embodiments, the particles may be an irregular shape or toroid, wherein the diameter across the largest point ranges from 60 to 200 nm.

In use, the particles [1] are added to sink holes to trace the movement of groundwater from the sink hole to one or more detection sites. Once added to the groundwater, the particles [1] are permitted to move freely, together with the groundwater. After a period of time, such as weeks or months, samples of groundwater are taken from multiple detection sites. In order to conduct the analysis, the samples of water are first subjected to ultrafiltration to remove matter of less than 100 kDa in size and so as to increase the concentration of particles [1] in the sample. The nucleic acid tag [2] is then extracted from the particles [1]. BMDB [7] can be cleaved by periodates, which facilitates the release of the nucleic acid [2] from the particle. The particles cannot withstand high temperatures so when the sample is heated to 95° C. for 10 minutes, for example, in the process of PCR, the nucleic acid [2] is released. Also, guanidine hydrochloride and ethanol extraction are used to obtain the nucleic acid tag [2]. The fact that the particle cannot withstand higher temperatures does not affect its use in groundwater systems, as these are unlikely to reach temperatures above 30° C.

The nucleic acids are then quantitatively amplified by real-time PCR using the addition of fluorescently labelled probes which are complementary to the identifying regions of the nucleic acid tags. Further details of real time quantitation of nucleic acid tags are provided in WO00/61799 which is hereby incorporated by reference.

It is to be appreciated that in other embodiments alternative XL2 molecules [7] may be used in place of DMDB. Other sulphydryl-specific crosslinking reagents based on maleimide or pyridyldithiol reactive groups which selectively covalently conjugate to protein and peptide thiols (reduced cysteines) or thiol polymers and/or oligonucleotides to form stable thioether bonds are listed below. They confer different advantages and are available from Pierce, Thermo Fisher Scientific, Loughborough, UK. Further details of the structures and properties of these particles are available from www.piercenet.com.

BM(PEG)2: 1,8-bis-maleimidodiethyleneglycol: eight atom polyether spacer reduces potential for conjugate precipitation in sulphhydryl-to-sulphydryl crosslinking applications;
BM(PEG)3: 1,11-bis-maleimidotriethyleneglycol: eleven atom polyether spacer provides more reach and reduces potential for conjugate precipitation;
BMB: 1,4-bismaleimidobutane: a non-cleavable, homobifunctional, sulphhydryl-reactive crosslinker with a four carbon spacer;
BMH: bismaleimidohexane: ideal for homobifunctional sulphhydryl-reactive crosslinking;
BMOE: bismaleimidoethane: short spacer sulphydryl-to sulphydryl crosslinking;
DPDPB: 1,4-di-[3′-(2′-pyridyldithio)-propionamido]butane: a cleavable, sulphydryl-reactive homobifunctional crosslinker;
DIME: dithio-bismaleimidoethane: cleavable sulphydryl-to-sulphydryl crosslinking agent;

HBVS: 1,6-hexane-bis-vinylsulfone: sulphydryl reactivity without the hydrolysis potential of maleimides; and

TMEA: tris-[2-maleimidoethyl]amine: sulphydryl-reactive tool for preparing trimeric aggregates.

### EXPERIMENTAL

### Reaction of XLP-BMDB

The cationic cross-linking polymer, XLP, is firstly reduced to provide a free thiol (—SH) group. In a round bottom flask, equipped with a magnetic stirrer and nitrogen inlet, MBA/DMEDA22-SH (reduced XLP) polymer (72.5 mg, 50.26 mmol) was dissolved under an inert atmosphere in distilled water (14.5 ml). A two fold excess of 1,4-bismaleimidyl-2,3-dimhydroxybutane (BMDB) was used (compared to —SH of XLP, 6.10 mg). The BMDB was purchased from Pierce, Thermo Fisher Scientific, Loughborough, UK. The —SH groups were quantified using the Ellman's test (Ellman G. L 1959, Arch Biochem Biophys 82, 70-77). The reaction is shown in FIG. 3.

The BMDB was dissolved in DMSO (dimethylsulfoxide) or DMF (dimethylformamide) (4.676 ml). The BMDB solution was then added to the polymer solution, the pH was adjusted to 7 and the reaction mixture was allowed to react for 1 h at room temperature. The reaction mixture was ultrafiltered through a 1,000 nominal cut-off using distilled water and lyophilised. The product was isolated after freeze drying.

Yield: 84.6%

### Making of Complexes/Particles

Oligo (5 μg) was mixed at 1.25:1 ratio with the polyamidoamines to form a DNA polycation complex. The ratio is calculated by DNA bases per monomer of the polymer. Two different types of oligos were used, one having a thiol at the 5′ end and one without a thiol group.

The ratio of XLP-BMDB to PEG-MBA/DMEDA25-SH-PEG copolymer (CP) was varied (1:1, 1.25:1 and 1.5:1). The order of addition of reagents is important, so XLP-BMDB (60 μl) was added to PEG-MBA/DMEDA25-SH-PEG (40 μl), then the polymers were added to oligonucleotides (5 μg in 100 μl).

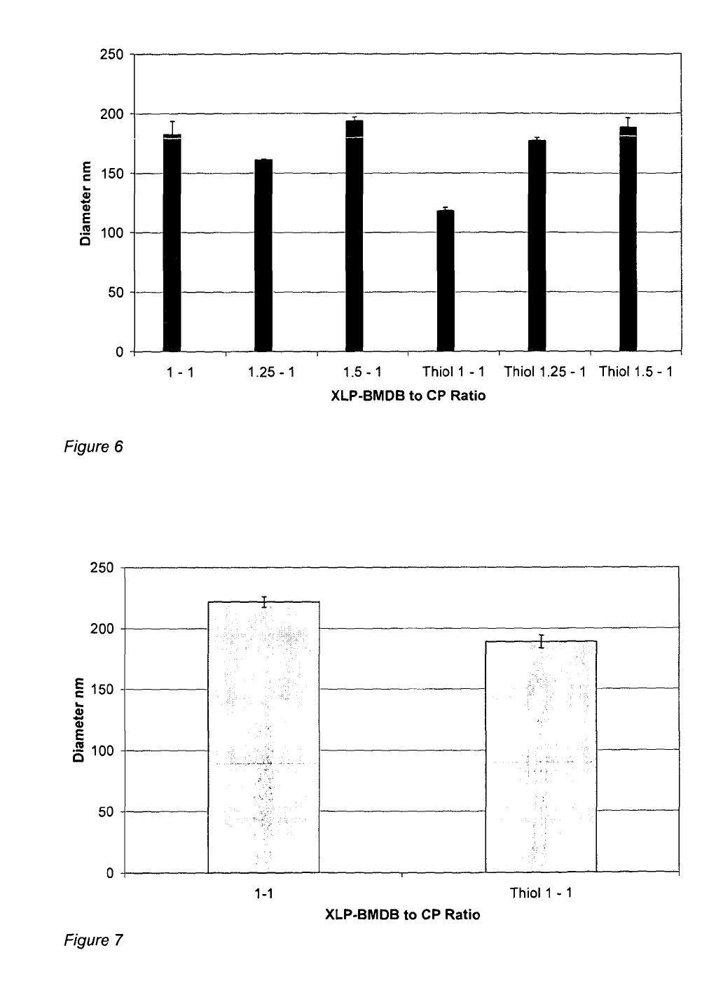

The sizes of the particles comprising polyamidoamine (PAA) polymer and DNA were determined using Dynamic Light Scattering (DLS) and the results are shown in FIGS. 6 and 7.

### Behaviour of the Complexes in the Presence of Reducing Agent, Dithiothreitol (DTT)

A comparative test was carried out to show the variation in particle stability under reducing conditions due to the addition of DMBD in the particle formulation. The results are shown in table 1. The thio-ether bond that is formed when DMDB is present in the particle should be stable under reducing conditions, in the presence of DTT. This is in contrast to a disulphide bond, which is present in alternative “surface water” particle formulations without DMDB. 100 mM of DTT was added to the particles and the complexes were then placed on top of a centrifugal filter (cut off MW: 1000 kDa, microsep, Pall Life, VWR International, Lutterworth, UK) and spun at 5000 g for 10 min. The amount of DNA that went through is a measure the stability of the particles. The “surface water” particle formulation (1.5 to 1 XLP to copolymer (CP) and 1.25 to 1 polyamidoamine (PAA) to thiolated oligo) is unstable in the presence of DTT as seen by the loss of viable particles in Table 1, while the new formulations are stable to DTT. This confirms that the particles are cross linked through the BMDB system

TABLE 1
Behaviour of complexes in the presence of reducing agent, DTT.

| | % viable | % viable particles after |
|---|---|---|
| Formulation | particles | incubation with DTT |
| 1.5 to 1 XLP to CP | 92.3 | 65.7 |
| 1.25 to 1 PAA to thiolated oligo | | |
| 1 to 1 XLP-BMDB to CP | 100 | 100 |
| 1.25 to 1 polyamidoamine to non | | |
| thiolated oligo | | |
| 1 to 1 XLP-BMDB to CP | 95 | 95 |
| 1.25 to 1 polyamidoamine to | | |
| thiolated oligo | | |

1-23. (canceled)

24. A polymer particle comprising:
a nucleic acid molecule comprising a pendant disulphide, sulphydryl or activated sulphydryl moiety; and
a polyamidoamine polymer comprising a pendant disulphide, sulphydryl or activated sulphydryl moiety,
wherein the nucleic acid molecule is covalently cross-linked with the polyamidoamine polymer.

25. A particle according to claim 24, wherein the polyamidoamine polymer contains repeating groups X and Y, wherein the polymer is represented by the general formula I:—
{—[X]—[Y]—}ₙ (Formula I)
in which,
n is between 5 and 500;
the groups X, which may be the same or different, are amide-containing groups of the formula
[-L¹-CO—NR¹-L²-NR²—CO-L³-]-
wherein
L¹ and L³ independently represent optionally substituted alkylene chains, preferably optionally substituted ethylene groups;
L² represents an optionally substituted alkylene chain; and
R¹ and R² independently represent hydrogen or an optionally substituted alkyl group;
and the groups Y, which may be the same or different, represent amine-derived groups of the formula:—
—[—NR³—]— or —[—NR⁴-L⁴-NR⁵—]—
wherein
R³, R⁴ and R⁵ independently represent optionally substituted alkyl groups, and
L⁴ represents an optionally substituted alkylene group;
or R⁴, R⁵ and L⁴, together with the nitrogen atoms to which they are attached, form an optionally substituted ring,
with the proviso that at least some of R³, R⁴ and R⁵ contain disulphide, sulphydryl or activated sulphydryl groups.

26. A particle according to claim 24, wherein the polyamidoamine polymer is bonded to a poly(ethylene glycol) group at one or both of its terminal ends.

27. A particle according to claim 24, wherein the particle further comprises a cationic cross-linking agent, XLP, having the formula: 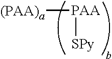
wherein the ratio of a/b is 3
wherein PAA represents {—[X]—[Y]—}
in which,
n is between 5 and 500;
the groups X, which may be the same or different, are amide-containing groups of the formula
-[-L¹-CO—NR¹-L²-NR²—CO-L³-]-
wherein
L¹ and L³ independently represent optionally substituted alkylene chains, preferably optionally substituted ethylene groups;
L² represents an optionally substituted alkylene chain; and
R¹ and R² independently represent hydrogen or an optionally substituted alkyl group;
and the groups Y, which may be the same or different, represent amine-derived groups of the formula:—
—[—NR³—]— or —[—NR⁴-L⁴-NR⁵—]—
wherein
R³, R⁴ and R⁵ independently represent optionally substituted alkyl groups, and
L⁴ represents an optionally substituted alkylene group;
or R⁴, R⁵ and L⁴, together with the nitrogen atoms to which they are attached, form an optionally substituted ring,
with the proviso that at least some of R³, R⁴ and R⁵ contain disulphide, sulphydryl or activated sulphydryl groups.
and SPy represents a sulphur pyridyl moiety,
and wherein the XLP is cross-linked with the nucleic acid molecule and the polyamidoamine polymer.

28. A particle according to claim 27 wherein the XLP used for cross-linking has the formula: 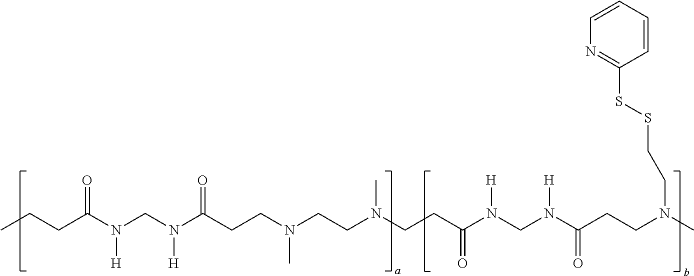
wherein the ratio of a/b is 3.

29. A particle according to claim 27, wherein the particle further comprises a second cross-linker (XL2), wherein the XL2 used for cross-linking is selected from the group consisting of:
1,4-bismaleimidyl-2,3-dihydroxybutane (BMDB);
1,8-bis-maleimidodiethyleneglycol (BM(PEG)2);
1,11-bis-maleimidotriethyleneglycol (BM(PEG)3);
1,4-bismaleimidobutane (BMB);
bismaleimidohexane (BMH);
bismaleimidoethane (BMOE);
1,4-di-[3′-(2′-pyridyldithio)-propionamido]butane (DPDPB);
dithio-bismaleimidoethane (DTME);
1,6-hexane-bis-vinylsulfone (HBVS); and
tris-[2-maleimidoethyl]amine (TMEA),
and wherein the XL2 is cross linked with the XLP, the nucleic acid molecule and the polyamidoamine polymer, so as to bind the nucleic acid and the XLP to the polyamidoamine polymer.

30. A particle according to claim 29, wherein the XL2 used for cross-linking is 1,4-bismaleimidyl-2,3-dihydroxybutane (BMDB):

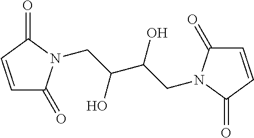 [SMILES: O=C1C=CC(=O)N1CC(O)C(O)CN1C(=O)C=CC1=O]

31. A particle according to claim 29, wherein the XLP and XL2 are present in a molar ratio of between 1:1.5 and 1:3.

32. A particle according to claim 31, wherein the XLP and XL2 are present in a molar ratio of 1:2.

33. A particle according to claim 26 wherein the polyamidoamine polymer comprises a poly(ethylene glycol) group bonded to its terminal ends, and has the formulation: 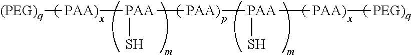
in which
PAA represents {—[X]—[Y]—} in which,
n is between 5 and 500;
the groups X, which may be the same or different, are amide-containing groups of the formula
-[-L¹-CO—NR¹-L²-NR²—CO-L³-]-
wherein
L¹ and L³ independently represent optionally substituted alkylene chains, preferably optionally substituted ethylene groups;
L² represents an optionally substituted alkylene chain; and
R¹ and R² independently represent hydrogen or an optionally substituted alkyl group;
and the groups Y, which may be the same or different, represent amine-derived groups of the formula:—
—[—NR³—]— or —[—NR⁴-L⁴-NR⁵—]—
wherein
R³, R⁴ and R⁵ independently represent optionally substituted alkyl groups, and
L⁴ represents an optionally substituted alkylene group;
or R⁴, R⁵ and L⁴, together with the nitrogen atoms to which they are attached, form an optionally substituted ring,
with the proviso that at least some of R³, R⁴ and R⁵ contain disulphide, sulphydryl or activated sulphydryl groups.
PEG represents poly(ethylene glycol),
wherein m is independently between 1 and 25, p is between 3 and 350,
q is independently between 1 and 60; and
x is independently between 0 and 50.

34. A particle according to claim 33, wherein m is independently between 1 and 10, p is between 5 and 50, q is independently between 10 and 50; and x is independently between 10 and 40.

35. A particle according to claim 34, wherein m is independently 4, p is 24, q is independently 38; and x is independently 24.

36. A particle according to claim 24, wherein the particle has a diameter of 70 to 200 nm.

37. A particle according to claim 24, wherein the nucleic acid molecule is between 80 and 100 bp long.

38. A particle according to claim 24, wherein the nucleic acid molecule is a single stranded oligonucleotide.

39. A particle according to claim 38, wherein the nucleic acid molecule is a single stranded DNA molecule.

40. A particle according to claim 24, wherein the pendant disulphide, sulphydryl or activated sulphydryl moiety of the nucleic acid molecule is present at the 5′ end.

41. A method of making the particle according to claim 29 comprising the steps of:
i). reducing a XLP;
ii). adding a XL2 to the XLP;
iii). combining a polyamidoamine polymer with the XLP-XL2 complex; and
iv). mixing the nucleic acid molecule with the PAA-XL2-XLP complex.

42. A method of marking a material comprising the steps of:
i). providing one or more particles as defined in claim 24; and
ii). applying the particles to the material.

43. A method according to claim 42, wherein the material is groundwater.

44. A method of detecting whether a material has been marked as defined in claim 42 comprising the steps of:
iii). sampling a portion of the material; and
iv). detecting the presence of the nucleic acid molecule in the sample.

45. A method according to claim 44 wherein step iv) further comprises the step of concentrating the amount of nucleic acid molecule by sample filtration.

46. A method according to claim 44, wherein step iv) further comprises the step of extracting the nucleic acid molecule from the marker particles.

47. A method according to claim 44, wherein step iv) further comprises the step of determining the quantity of the nucleic acid molecule present in the sample, preferably by real time PCR.

48. A method of marking a plurality of materials comprising the steps of claim 42 wherein each material is marked with a separate set of polymer particles, the polymer particles in each set comprising nucleic acid molecule having a different sequence.

49. A method of detecting a material according to claim 44, wherein steps iii) is carried out at least one week after step ii) has occurred.

50. A method of using a particle according to claim 24 for marking a material.
